(19) United States
(12) Patent Application Publication
(10) Pub. No.: US 2025/0164056 A1
(43) Pub. Date: May 22, 2025

(54) Closet Flange Plug

(71) Applicants: Brian F. Jackman, Worcester, MA (US); Christopher M. Jackman, Framingham, MA (US); John D. Jackman, Framingham, MA (US)

(72) Inventors: Brian F. Jackman, Worcester, MA (US); Christopher M. Jackman, Framingham, MA (US); John D. Jackman, Framingham, MA (US)

(21) Appl. No.: 18/952,539

(22) Filed: Nov. 19, 2024

Related U.S. Application Data
(60) Provisional application No. 63/601,933, filed on Nov. 22, 2023.

(51) Int. Cl. F16L 55/11

(52) U.S. Cl. CPC F16L 55/1116

(57) ABSTRACT

A closet flange plug for sealing an opening of a closet flange and for being cut away by operation of a hole saw. The closet flange plug has an annular body portion for sealing the closet flange opening and a drill guide post concentrically disposed within the body portion. The drill guide post has a solid base portion of a material, such as polyvinyl chloride (PVC) thermoplastic, operative to bind in the hole saw drill bit. The annular body portion is adapted to be cut through by the hole saw. The drill guide post has an upper portion projecting above the annular body portion while the base portion projects below the annular body portion. A borehole concentrically disposed within the upper portion of the guide post has a portion sized to interfere with and be drilled into by the hole saw drill bit.

### RELATED APPLICATION

This application claims priority to U.S. Provisional Application No. 63/601,933, filed Nov. 22, 2023, which is incorporated herein by reference.

### FIELD OF THE INVENTION

The present invention relates generally to waste systems. More particularly, disclosed herein is a plug for capping a waste port, such as an opening of a toilet closet flange, for testing or other purposes. The plug is efficiently removable by rotary cutting without risk of inadvertent detachment and without risk if dropping through the closet flange and into a waste pipe.

### BACKGROUND OF THE INVENTION

The installation of a conventional toilet typically involves bolting the toilet to a flange. The flange is, in turn, attached to the floor. The flange is commonly referred to as a toilet flange or a closet flange. The closet flange operates to mount the toilet securely to the floor while also connecting the toilet to a wastewater pipe that leads to a sewer pipe.

The connections between the toilet base, the closet flange, and the wastewater pipe must be secure and fluid tight for safety, sanitation, and to meet applicable plumbing codes. It is thus commonly required during building construction to perform an air or water test of the plumbing to ensure that the pipes, fixtures, and fittings are properly connected without fluid leaks. As such, to permit testing, the toilet flange and other openings in the system must be temporarily blocked with some removable stopper, such as a plug, cap, or other stopper. When the testing is complete, the stopper or plug must be removed.

Another challenge faced by plumbers derives from the fact that wastewater pipes are typically installed long before the toilet is mounted. As a result, the vertical opening of the wastewater pipe may be left open during construction. Construction debris, such as sawdust, nails, wood chips, putty, screws, tape, paper, and even blocks of wood, may fall into the open upper end of the drain pipe to cause major blockages, which may become apparent only after the newly completed building is occupied. Some plumbers use cloth, plastic, wood, or tape as temporary coverings, but it may still be necessary to apply a stopper for testing that provides a fluid tight seal.

The ideal would thus be a stopper that effectively closes the opening of a closet flange or other plumbing aperture, that reliably stays in place during testing, and that can be conveniently and efficiently removed when testing is complete. The mechanical, pneumatic, and other methods and devices of the prior art have struggled to meet these needs. Indeed, despite the pressures used in such testing being relatively low, many sealing mechanisms of the prior art are prone to being blown out of place thereby requiring resealing and retesting. Other plugs may resist inadvertent displacement, but that very characteristic often renders them difficult and frustrating to remove. Still further, and much to the consternation of the plumber, many plugs of the prior art, such as plugs that are knocked out by impact, have a risk of falling into the wastewater pipe upon being detached from the aperture so that the plumber must go through a cumbersome process of extracting the plug from its position fallen into the pipe. Moreover, where a plug must be knocked out by impact, there is a real risk of damaging the closet flange itself.

The present inventors thus appreciated a real need in the art for a plug for a closet flange or other plumbing opening that provides an effective fluidic and mechanical seal relative to the plumbing opening, that resists inadvertent displacement, and that can be efficiently removed upon the completion of testing without risk of falling into the lumen of the pipe to which it had been applied.

### SUMMARY OF THE INVENTION

In view of the foregoing, the present invention is founded on the basic object of providing a plug for a closet flange or other plumbing opening that provides a reliable fluidic and mechanical sealing of the opening.

A further object of the invention is to provide a plug for a closet flange or other plumbing opening that resists inadvertent displacement and that can be removed without the need for the application of an impact force and without the concomitant risk of damage to the closet flange.

Another object of the invention is to provide a plug for a closet flange or other plumbing opening that can be quickly and efficiently removed from the opening without a risk of dropping into the lumen of the pipe to which it had been applied.

A related object of the invention is to provide a plug for a closet flange or other plumbing opening that renders plumbing pressure testing more efficient and effective.

These and further objects, advantages, and details of the present invention will become obvious not only to one who reviews the present specification and drawings but also to those who have an opportunity to make use of an embodiment of the closet flange plug disclosed herein. Although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In carrying forth one or more of the foregoing objects, an embodiment of the closet flange plug for sealing an opening of a closet flange and for being cut away by operation of a hole saw with a drill bit and an annular saw portion can be considered to be founded on an annular body portion for aligning with and sealing the opening of the closet flange. A drill guide post is concentrically disposed within the body portion. The drill guide post has a base portion that is solid in material for being drilled into by the drill bit of the hole saw, and the annular body portion of the closet flange plug is adapted to be cut through by the annular saw portion of the hole saw.

At least the drill guide post is formed from a material that is operative to bind in the drill bit of the hole saw in response to drilling into the drill guide post. With that, when a hole saw is employed to remove the closet flange plug from a position affixed in sealing the opening of the closet flange, the annular saw portion of the hole saw will cut through the annular body portion of the closet flange plug as the drill bit of the hole saw drills into the drill guide post to cause the material of the post to bind in the drill bit of the hole saw thereby to cause the closet flange plug to be retained relative to the hole saw for removal from the closet flange.

In embodiments of the closet flange plug, the drill guide post comprises a material that is operative to become gummy and sticky to bind in the drill bit of the hole saw in response to drilling into the drill guide post. For instance, the drill guide post can be formed from a plastic, such as polyvinyl chloride (PVC) plastic.

The closet flange plug can be fastened to a closet flange, such as by adhesive or otherwise. Alternatively, the closet flange wherein the closet flange plug can be formed integrally with the closet flange.

In certain embodiments, the drill guide post has an upper portion that projects above the annular body portion while the base portion of the drill guide post projects below the annular body portion. Further, a borehole can be concentrically disposed within the upper portion of the guide post. In such practices of the invention, the borehole can have a portion sized to interfere with and be drilled into by the drill bit of the hole saw and, potentially, a portion distal to the portion sized to interfere with and be drilled into by the drill bit of the hole saw that is sized to receive the drill bit of the hole saw without interference. By way of example, such as where the hole saw has a 0.25 inch drill bit, the portion sized to interfere with and be drilled into by the drill bit of the hole saw can have a diameter less than 0.25 inches while the portion distal to that portion can have a diameter of 0.25 inches or greater.

Alternative embodiments of the invention can be characterized as a combination of a closet flange with an opening and a closet flange plug for sealing the opening of the closet flange and for being cut away by operation of a hole saw with a drill bit and an annular saw portion. In such practices, the combination can be characterized as having a closet flange with an opening and a closet flange plug with an annular body portion sized for aligning with and sealing the opening of the closet flange. The closet flange plug again has a drill guide post concentrically disposed within the body portion. The drill guide post has a base portion that is solid in material for being drilled into by the drill bit of the hole saw. Moreover, the drill guide post will preferably be formed from a material that is operative to bind in the drill bit of the hole saw in response to drilling into the drill guide post while the annular body portion is adapted to be cut through by the annular saw portion of the hole saw. The closet flange plug can be fixed to the closet flange, such as by adhesive or any other effective method, or the closet flange plug could be formed integrally with the closet flange, such as by molding or in any other manner.

One will appreciate that the foregoing discussion broadly outlines the more important goals and features of the invention to enable a better understanding of the detailed description that follows and to instill a better appreciation of the inventors' contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

In the accompanying drawing figures:

FIG. 1 is a top plan view of a closet flange plug according to the invention;

FIG. 2 is a bottom plan view of the closet flange plug of FIG. 1;

FIG. 3 is a view in side elevation of the closet flange plug of FIG. 1;

FIG. 4 is a cross-sectional view of the closet flange plug taken along the line A-A in FIG. 1;

FIG. 5 is perspective view of a toilet mounting flange according to the prior art;

FIG. 6 is a perspective view of an embodiment of the closet flange plug pursuant to the present invention;

FIG. 7 is a perspective view of a closet flange plug as taught herein positioned within the toilet mounting flange;

FIG. 8 is a cross-sectional view of the closet flange plug positioned within the toilet mounting flange taken along the line C-C in FIG. 7 where the closet flange plug is affixed to the toilet mounting flange;

FIG. 9 is a cross-sectional view of the closet flange plug positioned within the toilet mounting flange taken along the line C-C in FIG. 7 where the closet flange plug is integrally formed with the toilet mounting flange;

FIG. 10 is a top plan view of an alternative embodiment of the closet flange plug;

FIG. 11 is a view in side elevation of the closet flange plug of FIG. 10;

FIG. 12 is a view in front elevation of the closet flange plug of FIG. 10;

FIG. 13 is a bottom plan view of the closet flange plug of FIG. 10;

FIG. 14 is a cross-sectional view of the closet flange plug of FIG. 10 taken along the line A-A in FIG. 10; and

FIG. 15 is a cross-sectional view of the closet flange plug of FIG. 10 taken along the line B-B in FIG. 10.

### DETAILED DESCRIPTION OF PREFERRED EMBODIMENTS

The toilet flange plug disclosed herein is subject to a variety of embodiments, each within the scope of the invention. However, to ensure that one skilled in the art will be able to understand and, in appropriate cases, practice the present invention, certain preferred embodiments of the broader invention revealed herein are described below and shown in the accompanying drawing figures.

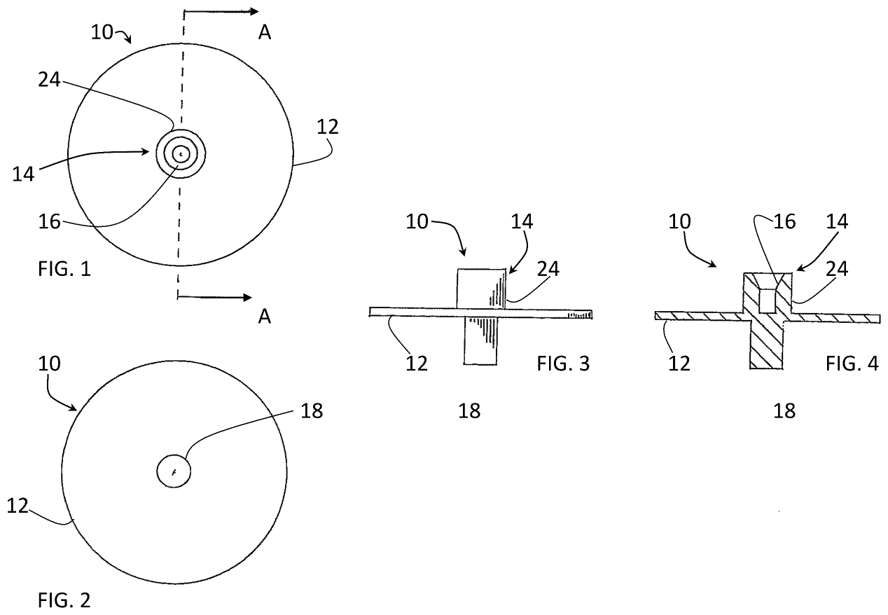

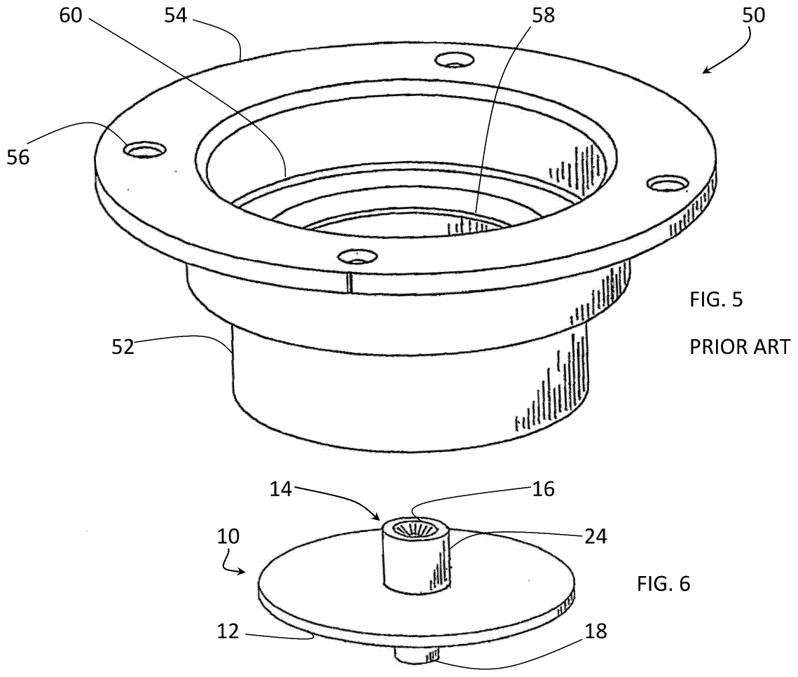

Turning more particularly to the drawings, an embodiment of the closet flange plug according to the present invention is indicated generally at 10 in FIGS. 1 through 4. There, the closet flange plug 10 can be seen to be founded on an annular body portion 12 for aligning with and sealing a plumbing opening, such as the drain aperture of a closet flange. A drill guide post 14 is concentrically disposed within the body portion 12. The guide post 14 has an upper portion 24 that projects above the annular body portion 12 and a base portion 18 that, in the present embodiment, extends and projects below and beyond the annular body portion 12 of the closet flange plug 10, but such extension and protection need not necessarily be the case.

As seen in FIG. 4, a borehole 16 is concentrically disposed within the upper portion 24 of the guide post 14. The borehole 16 has a distal top portion that is of a diametrical size that is predetermined to receive a drill bit of a hole saw. For instance, recognizing that many hole saw drill bits are of 0.25 inch diameters, the distal top portion of the borehole 16 in certain embodiments has a 0.25 inch diameter opening. The guide post 14 further has a central portion proximal to the distal portion that narrows to have a borehole of a diametrical size less than the diametrical size of the distal top portion and thus less than diameter of the drill bit of the hole saw. Thus, again recognizing that many hole saw drill bits are of 0.25 inch diameters, the central portion of the guide post 14 can have a borehole with a diametrical size of less than 0.25 inches. As such, while the distal portion of the borehole 16 allows free entrance of the hole saw drill bit, the central portion of the guide post 14 will interfere with and be drilled by the drill bit of the hole saw.

As above, the base portion 18 of the guide post 14 in the present embodiment of the invention extends and projects below and beyond the annular body portion 12 of the closet flange plug 10. Again, however, the base portion 18 need not necessarily project below or entirely below the annular body portion 12 of the closet flange plug 10 and could instead be disposed partially or entirely above the annular body portion 12. In either event, the base portion 18 of the guide post 14 is solid in material such that it can be drilled into by the drill bit of the hole saw.

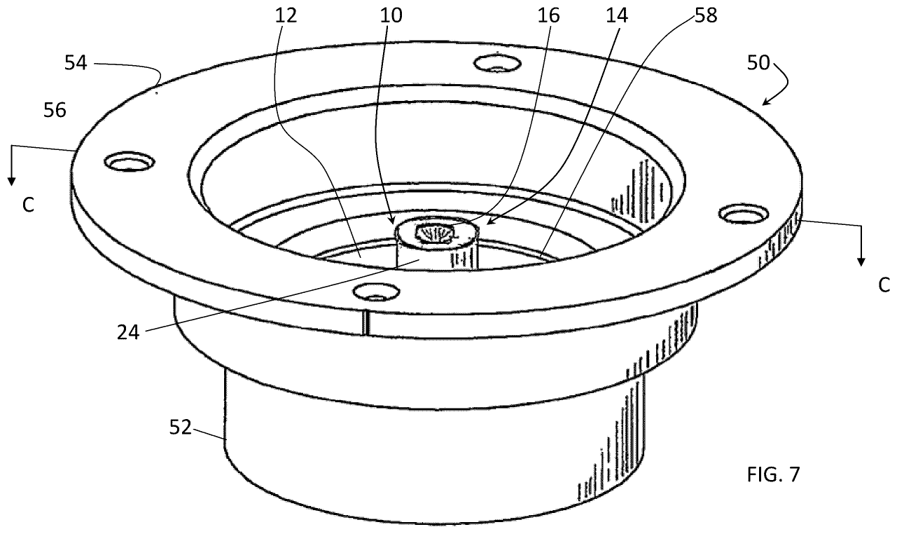

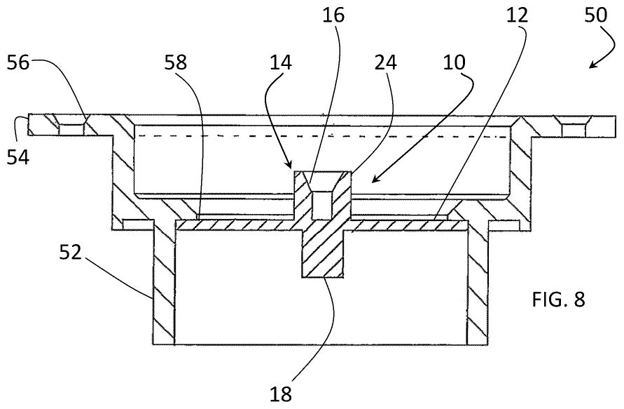

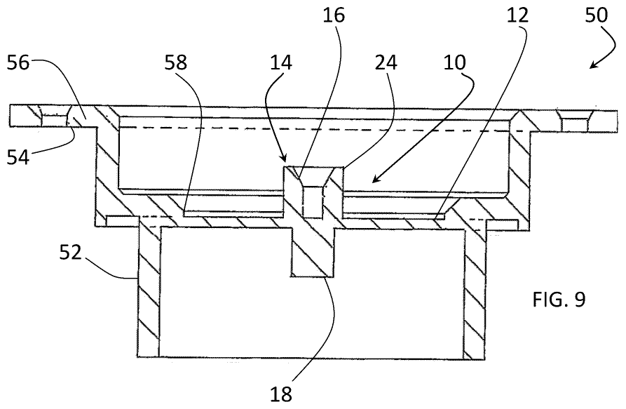

So constructed, the closet flange plug 10 can be disposed to seal the opening of a closet flange 50 as is shown, for example, in FIGS. 7 through 9. There, the prior art closet flange 50, which is shown alone in FIG. 5, can be seen to have a tubular wall 52 for being matingly received into a wastewater pipe (not shown). An annular flange 54 extends radially and concentrically in relation to the tubular wall 52, and a tapered, stepped opening 58 is provided for receiving the horn of a toilet (not shown) and for providing a passage into the wastewater pipe. Mounting apertures 56 are spaced around the annular flange 54 for permitting a fastening of the closet flange 50 to, for example, flooring within a building structure. As in FIG. 8, the closet flange plug 10 of the present invention can be formed as a separate member that is affixed, such as by adhesive or otherwise, to the closet flange 50 to seal the opening thereof. In the present example, the closet flange plug 10 is fixed to an underside of the stepped opening 58 at or adjacent to an upper end of the tubular wall 52. Alternatively, as FIG. 9 shows, the closet flange plug 10 could be integrally formed, such as by molding or otherwise, with the closet flange 50.

At least the guide post 14 of the closet flange plug 10, including the upper portion 24 and the base portion 18 thereof, is formed of a material that is operative to become gummy and sticky during drilling thereby tending to bind up in the flutes of the drill bit thereby to be retained by the drill bit and the hole saw in general. For instance, the present inventors have found that manufacturing the guide post 14 and potentially the entire closet flange plug 10 from a thermoplastic, alternatively referred to as a thermosoftening plastic, has produced the desired gumminess and stickiness necessary to produce the desired binding and retention effects. The thermoplastic in preferred embodiments can comprise polyvinyl chloride (PVC). Still further, according to embodiments of the closet flange plug 10, the material of the guide post 14 and perhaps the entire closet flange plug 10 can be formed from plasticized polyvinyl chloride (pPVC) with plasticizers added to the raw polyvinyl chloride material before molding thereby making it more flexible and pliable and enhancing the gummy and sticky properties sought for causing the closet flange plug 10 to be retained by the drill bit and the hole saw upon drilling and cutting into the closet flange plug 10. So constructed, the thermoplastic of the guide post 14 will tend to become pliable, gummy, and sticky as it heats during the process of drilling and will then solidify to bind to and within the flutes of the drill bit upon cooling.

Therefore, without regard to whether the closet flange plug 10 is integrally formed with the closet flange 50 as in FIG. 9 or affixed thereto as in FIG. 8, the material drilled into within the guide post 14 will soften upon drilling and cutting, bind in the flutes of the drill bit of the hole saw, and thus affix the closet flange plug 10 to the hole saw and the drill bit thereof. As the material of the drilled into within the guide post 14 gums up and binds within the flutes of the drill bit, the annular saw portion of the hole saw, which can for instance be sized to be approximately equal to the aperture of the stepped opening 58, cuts through the body portion 12 of the closet flange plug 10 thereby freeing the portion of the closet flange plug 10 interior of the saw portion of the hole saw from its position sealing the opening of the closet flange 50. Any portion of the body portion 12 extending broader than the radius of the saw portion of the hole saw will remain affixed to the closet flange 50 without impact on the use or operation of the closet flange 50 or the toilet retained thereby. Normal operation of the closet flange 50 and the toilet retained thereby are thus permitted.

The sticky material of the closet flange plug 10, particularly of the guide post 14 thereof, tends to bind in the flutes of the drill bit of the hole saw. Thus, the closet flange plug 10 will be securely retained by the drill bit and thus by the hole saw and the drill operating it. With that, the risk of the closet flange plug 10 inadvertently falling through the opening 58 of the closet flange 50 and into the wastewater pipe is eliminated. Moreover, and particularly where the base portion 18 of the closet flange plug 10 projects through the body portion 12, once the closet flange plug 10 has been cut from the closet flange 50 by operation of the hole saw, the base portion 18 of the closet flange plug 10 can be gripped, such as by pliers or otherwise, to permit removal of the closet flange plug 10 from within the hole saw, potentially while the hole saw is reversed if and as necessary.

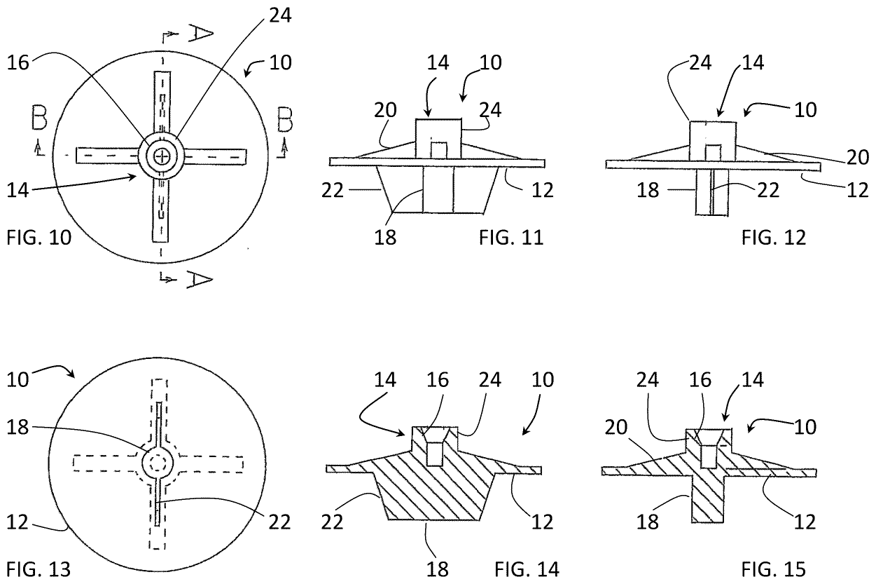

An alternative embodiment of the closet flange plug 10 is shown in FIGS. 10 through 15. There, the closet flange plug 10 is again founded on an annular body portion 12, and a drill guide post 14 is concentrically disposed within the body portion 12. The guide post 14 again has an upper portion 24 that projects above the annular body portion 12. A borehole 16 is concentrically disposed within the upper portion of the guide post 14.

The borehole 16 has a distal portion within the upper portion 24 that is sized, such as with a 0.25 inch diameter opening, to receive a drill bit of a hole saw. A central portion of the guide post 14 is disposed proximal to the distal portion. The central portion narrows to have a borehole sized, such as with less than a 0.25 inch diameter opening, to interfere with and be drilled by the drill bit of the hole saw. The guide post 14 again has a base portion 18 that is solid in material that extends and projects below and beyond the annular body portion 12 of the closet flange plug 10. To this extent, the closet flange plug 10 is constructed as with the embodiment described hereinabove, and that description applies to the present embodiment except as otherwise indicated.

In the present manifestation of the closet flange plug 10, however, upper stabilizing fins 20 are formed to span from the upper portion 24 of the guide post 14 to the upper surface of the annular body portion 12. Moreover, lower stabilizing fins 22 are formed to span from the base portion 18 of the guide post 14 to the lower surface of the annular body portion 12. With this, added strength and stability are provided to the upper and base portions 24 and 18 of the guide post 14. Moreover, the fins 20 and 22 can be employed to facilitate a gripping of the closet flange plug 10, such as during removal of the plug 10 from the drill bit and the hole saw in general.

With certain details and embodiments of the present invention for a closet flange plug 10 disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall define the scope of protection to be afforded to the inventors. Those claims shall be deemed to include equivalent constructions insofar as they do not depart from the spirit and scope of the invention. Certain claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

What is claimed as deserving the protection of Letters Patent:

1. A closet flange plug for sealing an opening of a closet flange and for being cut away by operation of a hole saw with a drill bit and an annular saw portion, the closet flange plug comprising:
an annular body portion for aligning with and sealing the opening of the closet flange;
a drill guide post concentrically disposed within the body portion;
wherein the drill guide post has a base portion that is solid in material for being drilled into by the drill bit of the hole saw, wherein the annular body portion is adapted to be cut through by the annular saw portion of the hole saw, and wherein the drill guide post is formed from a material that is operative to bind in the drill bit of the hole saw in response to drilling into the drill guide post.

2. The closet flange plug of claim 1, wherein the drill guide post comprises a material that is operative to become gummy and sticky to bind in the drill bit of the hole saw in response to drilling into the drill guide post.

3. The closet flange plug of claim 2, wherein the drill guide post is formed from a thermoplastic.

4. The closet flange plug of claim 3, wherein the drill guide post is formed from polyvinyl chloride (PVC) plastic.

5. The closet flange plug of claim 1, wherein the closet flange plug is adapted for being fastened to a closet flange.

6. The closet flange plug of claim 5, further comprising a closet flange wherein the closet flange plug is fixed to the closet flange.

7. The closet flange plug of claim 1, further comprising a closet flange wherein the closet flange plug is formed integrally with the closet flange.

8. The closet flange plug of claim 1, wherein the drill guide post has an upper portion that projects above the annular body portion and wherein the base portion of the drill guide post projects below the annular body portion.

9. The closet flange plug of claim 8, further comprising a borehole concentrically disposed within the upper portion of the guide post.

10. The closet flange plug of claim 9, wherein the borehole has a portion sized to interfere with and be drilled into by the drill bit of the hole saw.

11. The closet flange plug of claim 10, wherein the borehole has a portion distal to the portion sized to interfere with and be drilled into by the drill bit of the hole saw that is sized to receive the drill bit of the hole saw without interference.

12. The closet flange plug of claim 11, wherein the portion sized to interfere with and be drilled into by the drill bit of the hole saw has a diameter less than 0.25 inches.

13. A closet flange plug for sealing an opening of a closet flange and for being cut away by operation of a hole saw with a drill bit and an annular saw portion, the closet flange plug comprising:
an annular body portion for aligning with and sealing the opening of the closet flange;
a drill guide post concentrically disposed within the body portion;
wherein the drill guide post has an upper portion that projects above the annular body portion and a base portion that projects below the annular body portion; and
wherein the base portion of the drill guide post is solid in material for being drilled into by the drill bit of the hole saw and wherein the annular body portion is adapted to be cut through by the annular saw portion of the hole saw.

14. The closet flange plug of claim 13, further comprising a borehole concentrically disposed within the upper portion of the guide post.

15. The closet flange plug of claim 14, wherein the borehole has a portion sized to interfere with and be drilled into by the drill bit of the hole saw.

16. The closet flange plug of claim 15, wherein the borehole has a portion distal to the portion sized to interfere with and be drilled into by the drill bit of the hole saw that is sized to receive the drill bit of the hole saw without interference.

17. The closet flange plug of claim 14, wherein the portion sized to interfere with and be drilled into by the drill bit of the hole saw has a diameter less than 0.25 inches.

18. The closet flange plug of claim 13, wherein the drill guide post is formed from a material that is operative to bind in the drill bit of the hole saw in response to drilling into the drill guide post.

19. The closet flange plug of claim 18, wherein the drill guide post comprises a material that is operative to become gummy and sticky to bind in the drill bit of the hole saw in response to drilling into the drill guide post.

20. The closet flange plug of claim 19, wherein the drill guide post is formed from a thermoplastic.

21. The closet flange plug of claim 20, wherein the drill guide post is formed from polyvinyl chloride (PVC) plastic.

22. The closet flange plug of claim 13, further comprising a closet flange wherein the closet flange plug is fixed to the closet flange.

23. The closet flange plug of claim 13, further comprising a closet flange wherein the closet flange plug is formed integrally with the closet flange.

24. A combination of a closet flange with an opening and a closet flange plug for sealing the opening of the closet flange and for being cut away by operation of a hole saw with a drill bit and an annular saw portion, the combination comprising:
a closet flange with an opening;
a closet flange plug with an annular body portion sized for aligning with and sealing the opening of the closet flange and a drill guide post concentrically disposed within the body portion wherein the drill guide post has a base portion that is solid in material for being drilled into by the drill bit of the hole saw and wherein the drill guide post is formed from a material that is operative to bind in the drill bit of the hole saw in response to drilling into the drill guide post and wherein the annular body portion is adapted to be cut through by the annular saw portion of the hole saw.

25. The combination of claim 24, wherein the closet flange plug is fixed to the closet flange.

26. The combination of claim 24, wherein the closet flange plug is formed integrally with the closet flange.

27. The combination of claim 24, wherein the drill guide post comprises a material that is operative to become gummy and sticky to bind in the drill bit of the hole saw in response to drilling into the drill guide post.

28. The combination of claim 27, wherein the drill guide post is formed from a thermoplastic.

29. The combination of claim 28, wherein the drill guide post is formed from polyvinyl chloride (PVC) plastic.

30. The combination of claim 24, wherein the drill guide post has an upper portion that projects above the annular body portion and wherein the base portion of the drill guide post projects below the annular body portion.

31. The combination of claim 30, further comprising a borehole concentrically disposed within the upper portion of the guide post wherein the borehole has a portion sized to interfere with and be drilled into by the drill bit of the hole saw.
